(19) United States
(12) Patent Application Publication
(10) Pub. No.: US 2026/0081720 A1
(43) Pub. Date: Mar. 19, 2026

(54) COMMUNICATION METHOD AND INTERFACE CIRCUIT

(71) Applicant: Kioxia Corporation, Tokyo (JP)

(72) Inventor: Shinichi MIZUGUCHI, Kawasaki Kanagawa (JP)

(73) Assignee: Kioxia Corporation, Tokyo (JP)

(21) Appl. No.: 19/073,122

(22) Filed: Mar. 7, 2025

(30) Foreign Application Priority Data
Sep. 19, 2024 (JP) 2024-162426

(51) Int. Cl. H04L 1/00; H04L 27/26

(52) U.S. Cl. CPC H04L 1/0061; H04L 27/2656

(57) ABSTRACT

According to one embodiment, a communication method is provided. The communication method includes performing a first operation when a first condition is satisfied for B mode and A mode. The B mode uses B transmission unit. The A mode uses A transmission unit. The first operation generates a data frame by adding B error detection code and A error detection code to data. The B error detection code corresponds to the B transmission unit. The A error detection code corresponds to the A transmission unit. The communication method includes performing a second operation when a second condition is satisfied for the B mode and the A mode. The second operation generates a data frame by adding the B error detection code to data without adding the A error detection code to the data. The communication method includes transmitting the data frame generated in the first operation or the second operation.

### CROSS-REFERENCE TO RELATED APPLICATIONS

This application is based upon and claims the benefit of Japanese Patent Application No. 2024-162426, filed on Sep. 19, 2024; the entire contents of which are incorporated herein by reference.

### FIELD

Embodiments described herein relate generally to a communication method and an interface circuit.

### BACKGROUND

In a communication method in which a data frame including data and error detection code is transmitted, it is possible to perform an error detection of data using the error detection code on a reception side of the data frame. In the communication method, it is desired to improve data transfer efficiency.

### BRIEF DESCRIPTION OF THE DRAWINGS

FIG. 1 is a diagram illustrating a configuration of a system to which a communication method according to a first embodiment is applied;

FIG. 2 is a diagram illustrating an operation of a device on a transmission side according to the first embodiment;

FIGS. 3A and 3B are diagrams illustrating a format of a data frame according to the first embodiment;

FIG. 4 is a diagram illustrating an operation of a device on a reception side according to the first embodiment;

FIG. 5 is a sequence diagram illustrating an operation of the system according to the first embodiment;

FIG. 6 is a sequence diagram illustrating the operation of the system according to the first embodiment;

FIG. 7 is a diagram illustrating an operation of a device on a transmission side according to a second embodiment;

FIG. 8 is a diagram illustrating an operation of a device on a reception side according to the second embodiment;

FIG. 9 is a diagram illustrating an operation of a device on a transmission side according to a modified example of the second embodiment;

FIG. 10 is a diagram illustrating an operation of a device on a reception side according to the modified example of the second embodiment; and

FIGS. 11A to 11C are diagrams illustrating a format of a data frame according to a third embodiment.

### DETAILED DESCRIPTION

In general, according to one embodiment, there is provided a communication method. The communication method includes performing, when a first condition is satisfied for B mode that uses B transmission unit and A mode that uses A transmission unit, a first operation of generating a data frame by adding at least B error detection code corresponding to the B transmission unit to data. The communication method includes performing, when a second condition is satisfied for the B mode and the A mode, a second operation of generating a data frame by adding the B error detection code to the data without adding A error detection code to the data. The communication method includes transmitting the data frame generated in the first operation or the second operation.

Exemplary embodiments of a communication method will be explained below in detail with reference to the accompanying drawings. The present invention is not limited to the following embodiments.

### First Embodiment

A communication method according to a first embodiment enables a data frame including data and an error detection code to be transmitted, and an error detection of the data can be performed using the error detection code on a reception side of the data frame, but a devisal for improving a data transfer efficiency is made.

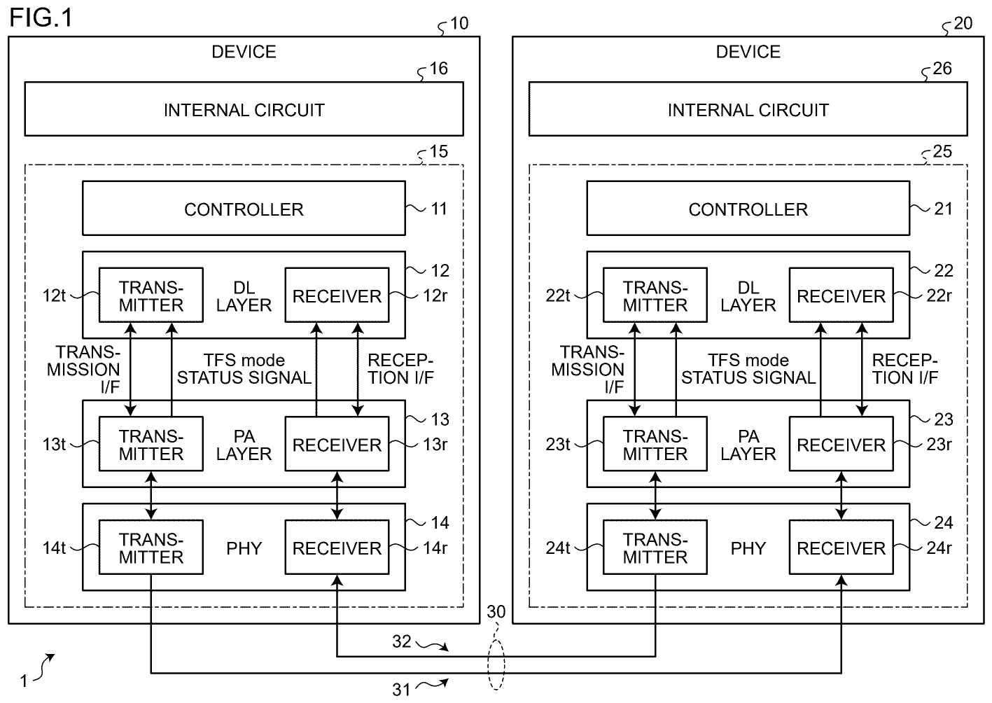

The communication method can be applied to a system 1 as illustrated in FIG. 1. FIG. 1 is a view illustrating a configuration of the system 1 to which the communication method is applied.

The system 1 includes a device 10, a device 20, and a communication channel 30.

The device 10 and the device 20 are communicably connected to each other via the communication channel 30. The communication channel 30 includes a communication line 31 and a communication line 32.

The device 10 can transmit a data frame to the device 20 via the communication line 31. The device 20 can receive the data frame from the device 10 via the communication line 31. The device 20 can transmit the data frame to the device 10 via the communication line 32. The device 10 can receive the data frame from the device 20 via the communication line 32.

The communication between the device 10 and the device 20 may be performed according to a predetermined communication standard. The predetermined communication standard defines an error detection code to compensate for an error in the data frame and guarantee that the data frame is correctly communicated. The error detection code includes a cyclic redundancy check (CRC) code. The device 10 and the device 20 respectively extract the error detection code from the received data frame, and performs a check (error detection) using the error detection code on the data in the data frame, so that whether the data has been correctly received can be confirmed.

The predetermined communication standard may support multiple communication modes MD_B, and MD_A. The communication mode MD_B uses a transmission unit TU_B. The transmission unit TU_B may have a fixed length. The communication mode MD_A uses a transmission unit TU_A. The transmission unit TU_A and the transmission unit TU_B may have a different data length. The transmission unit TU_A may have a variable length.

The data length of the transmission unit TU_B and the data length of the transmission unit TU_A may be the same. When a data frame is transmitted using the transmission unit TU_B, the data frame is transmitted across multiple transmission units TU_B in a case where the data length of the transmission unit TU_B and the data length of the transmission unit TU_A are the same, as there is a region for an error detection code of the transmission unit TU_B.

The device 10 performs an operation OP_A in a case where a condition CD_A is satisfied regarding the communication mode MD_B and the communication mode MD_A. The operation OP_A adds to data DT an error detection code CRC_A corresponding to the transmission unit TU_A and an error detection code CRC_B corresponding to the transmission unit TU_B to generate a data frame DF. The condition CD_A may include a part of the data frame DF being transmitted in the communication mode MD_A, and another part of the data frame DF being transmitted in the communication mode MD_B.

The device 10 performs an operation OP_B in a case where a condition CD_B is satisfied regarding the communication mode MD_B and the communication mode MD_A. The operation OP_B generates a TFS data frame TFS by adding the error detection code CRC_B to the data without adding the error detection code CRC_A to the data. The condition CD_B may include all the data frames DF being transmitted in the communication mode MD_B.

The device 10 transmits the data frame DF generated in the operation OP_A or the operation OP_B to the device 20 via the communication line 31.

Similarly, the device 20 performs the operation OP_A in a case where the condition CD_A is satisfied regarding the communication mode MD_B and the communication mode MD_A. The operation OP_A adds to data DT the error detection code CRC_B corresponding to the transmission unit TU_B and the error detection code CRC_A corresponding to the transmission unit TU_A to data DT to generate the data frame DF. The condition CD_A may include a part of the data frame DF being transmitted in the communication mode MD_A, and another part of the data frame DF being transmitted in the communication mode MD_B.

The device 20 performs the operation OP_B in a case where the condition CD_B is satisfied regarding the communication mode MD_B and the communication mode MD_A. The operation OP_B generates the data frame DF of the transmission unit TU_A without adding the error detection code CRC_A to the data, and thereafter, generates the TFS data frame TFS of the transmission unit TU_B by adding the error detection code CRC_B corresponding to the transmission unit TU_B. The condition CD_B may include that all the data frames DF being transmitted in the communication mode MD_B.

The device 20 transmits the data frame DF generated in the operation OP_A or the operation OP_B to the device 10 via the communication line 32.

The device 10 and the device 20 may be configured as illustrated in FIG. 1, in correspondence with the predetermined communication standard.

For example, the predetermined communication standard includes Unipro standard. The Unipro standard defines a layer data transmission structure including an application layer, a transport layer, a network layer, a data link layer (DL layer), and a physical adapter layer (PA layer).

In version 3.0 of the Unipro standard, a TFS (Transport Frame Structure) is introduced in the PA layer. A TFS mode and a non-TFS mode are prepared as a communication mode, where each device can transmit/receive data for every TFS unit when switched to the TFS mode.

The device 10 includes an interface circuit 15 and an internal circuit 16. The interface circuit 15 performs an interface operation in the communication with the device 20. The interface circuit 15 includes a controller 11, a DL layer 12, a PA layer 13, and a PHY 14. Each of the controller 11, the DL layer 12, the PA layer 13, and the PHY 14 may be constructed as a circuit.

The controller 11 corresponds to the application layer, the transport layer and the network layer in the layer data transmission structure. The DL layer 12 corresponds to the DL layer in the layer data transmission structure. The PA layer 13 and the PHY 14 correspond to the PHY layer in the layer data transmission structure.

The DL layer 12 includes a transmitter 12t and a receiver 12r. The PA layer 13 includes a transmitter 13t and a receiver 13r. The PHY 14 includes a transmitter 14t and a receiver 14r. Each of the transmitter 12t, the receiver 12r, the transmitter 13t, the receiver 13r, the transmitter 14t, the receiver 14r may be constructed as a circuit.

Upon receiving transmission information from the internal circuit 16, the controller 11 sequentially converts the transmission information to the formats of the application layer, the transport layer, the network layer, and the DL layer. The controller 11 supplies the transmission information of the format of the DL layer to the transmitter 12t.

The transmitter 12t can receive a TFS mode status signal from the transmitter 13t.

Upon receiving the TFS mode status signal in an active level, the transmitter 12t switches the communication mode to the TFS mode, and generates a data frame corresponding to the TFS mode based on the transmission information. The transmitter 12t supplies the data frame to the transmitter 13t.

Upon receiving the TFS mode status signal in a non-active level, the transmitter 12t switches the communication mode to a non-TFS mode, and generates a data frame corresponding to the non-TFS mode based on the transmission information. The transmitter 12t supplies the data frame to the transmitter 13t.

The transmitter 13t converts the data frame to a format of the PA layer. In the TFS mode, the transmitter 13t converts the data frame to the TFS and supplies the same to the transmitter 14t. In the non-TFS mode, the transmitter 13t converts the data frame to data of a format of the PA layer and supplies the same to the transmitter 14t.

In the TFS mode, the transmitter 14t converts the TFS to a format of the PHY layer, and transmits the same to the device 20 via the communication line 31. In the non-TFS mode, the transmitter 14t converts the data of the format of the PA layer to a format of the PHY layer and transmits the same to the device 20 via the communication line 31.

Upon receiving data from the device 20 via the communication line 32, in the TFS mode, the receiver 14r supplies data to the receiver 13r. In the non-TFS mode, the receiver 14r supplies data to the receiver 13r.

In the TFS mode, the receiver 13r converts the TFS to a data frame of a format of the DL layer and supplies the same to the receiver 12r. In the non-TFS mode, the receiver 13r converts the data of the format of the PA layer to the data frame of the format of the DL layer and supplies the same to the receiver 12r.

The receiver 12r can receive the TFS mode status signal from the receiver 13r.

Upon receiving the TFS mode status signal in the active level, the receiver 12r switches the communication mode to the TFS mode, generates reception information corresponding to the TFS mode based on the data frame, and converts the reception information to a format of the network layer.

Upon receiving the TFS mode status signal in the non-active level, the receiver 12r switches the communication mode to the non-TFS mode, generates reception information corresponding to the non-TFS mode based on the data frame, and converts the reception information to a format of the network layer.

The receiver 12r supplies the reception information to the controller 11.

Upon receiving the reception information, the controller 11 sequentially converts the reception information to formats of the network layer, the transport layer, and the application layer. The controller 11 supplies the reception information of the format of the application layer to the internal circuit 16.

The device 20 includes an interface circuit 25 and an internal circuit 26. The interface circuit 25 performs an interface operation in the communication with the device 20. The interface circuit 25 includes a controller 21, a DL layer 22, a PA layer 23, and a PHY 24. Each of the controller 11, the DL layer 12, the PA layer 13, and the PHY 14 may be constructed as a circuit.

The controller 21 corresponds to the application layer, the transport layer, and the network layer in the layer data transmission structure. The DL layer 22 corresponds to the DL layer in the layer data transmission structure. The PA layer 23 and the PHY 24 correspond to the PHY layer in the layer data transmission structure.

The DL layer 22 includes a transmitter 22t and a receiver 22r. The PA layer 23 includes a transmitter 23t and a receiver 23r. The PHY 24 includes a transmitter 24t and a receiver 24r. Each of the transmitter 22t, the receiver 22r, the transmitter 23t, the receiver 23r, the transmitter 24t, the receiver 24r may be constructed as a circuit.

Upon receiving the transmission information from the internal circuit 26, the controller 21 sequentially converts the transmission information to the formats of the application layer, the transport layer, the network layer, and the DL layer. The controller 21 supplies the transmission information of the format of the DL layer to the transmitter 22t.

The transmitter 22t can receive the TFS mode status signal from the transmitter 23t.

Upon receiving the TFS mode status signal in the active level, the transmitter 22t switches the communication mode to the TFS mode, and generates a data frame corresponding to the TFS mode based on the transmission information. The transmitter 22t supplies the data frame to the transmitter 23t.

Upon receiving the TFS mode status signal in the non-active level, the transmitter 22t switches the communication mode to the non-TFS mode, and generates a data frame corresponding to the non-TFS mode based on the transmission information. The transmitter 22t supplies the data frame to the transmitter 23t.

The transmitter 23t converts the data frame to the format of the PA layer. In the TFS mode, the transmitter 23t converts the data frame to the TFS, and supplies the same to the transmitter 24t. In the non-TFS mode, the transmitter 23t converts the data frame to the data of the format of the PA layer, and supplies the same to the transmitter 24t.

In the TFS mode, the transmitter 24t converts the TFS to the format of the PHY layer and transmits the same to the device 20 via the communication line 31. In the non-TFS mode, the transmitter 24t converts the data of the format of the PA layer to the format of the PHY layer and transmits the same to the device 20 via the communication line 32.

Upon receiving data from the device 20 via the communication line 32, in the TFS mode, the receiver 24r supplies the data to the receiver 23r. In the non-TFS mode, the receiver 24r supplies the data to the receiver 23r.

In the TFS mode, the receiver 23r converts the TFS to the data frame of the format of the DL layer and supplies the same to the receiver 22r. In the non-TFS mode, the receiver 23r converts the data of the format of the PA layer to the data frame of the format of the DL layer and supplies the same to the receiver 22r.

The receiver 22r can receive the TFS mode status signal from the receiver 23r.

Upon receiving the TFS mode status signal in the active level, the receiver 22r switches the communication mode to the TFS mode, generates reception information corresponding to the TFS mode based on the data frame, and converts the reception information to the format of the network layer.

Upon receiving the TFS mode status signal in the non-active level, the receiver 22r switches the communication mode to the non-TFS mode, generates reception information corresponding to the non-TFS mode based on the data frame, and converts the reception information to the format of the network layer.

The receiver 22r supplies the reception information to the controller 21.

Upon receiving the reception information, the controller 21 sequentially converts the reception information to the formats of the network layer, the transport layer, and the application layer. The controller 21 supplies the reception information of the format of the application layer to the internal circuit 26.

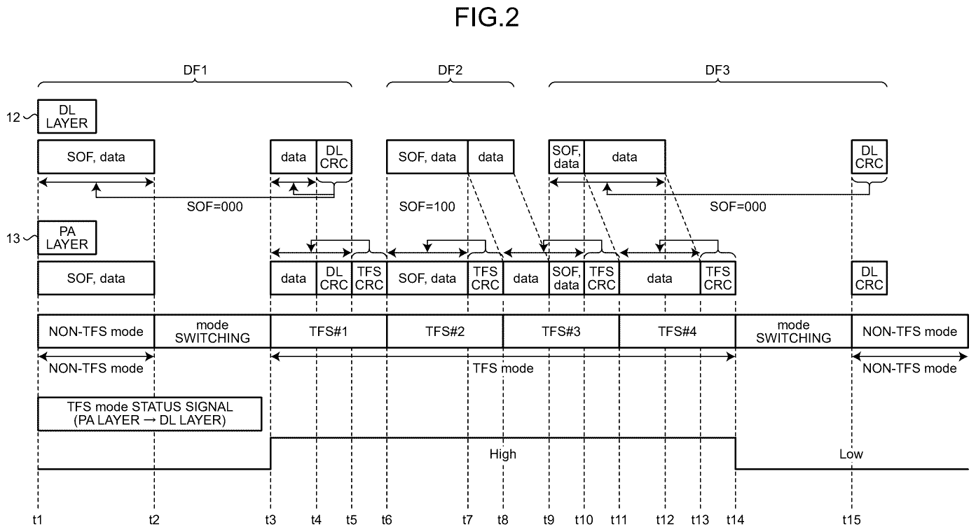

Next, an operation of the device on the transmission side will be described with reference to FIG. 2. FIG. 2 is a diagram illustrating an operation of the device on the transmission side. FIG. 2 illustrates a case where the device on the transmission side is the device 10. In FIG. 2, the operations of the DL layer 12 and the PA layer 13 will be mainly described.

At timing t1, the PA layer 13 supplies the TFS mode status signal in the non-active level to the DL layer 12. The DL layer 12 and the PA layer 13 respectively operate in the non-TFS mode. The DL layer 12 starts to provide the data frame DF1 corresponding to the non-TFS mode based on the transmission information.

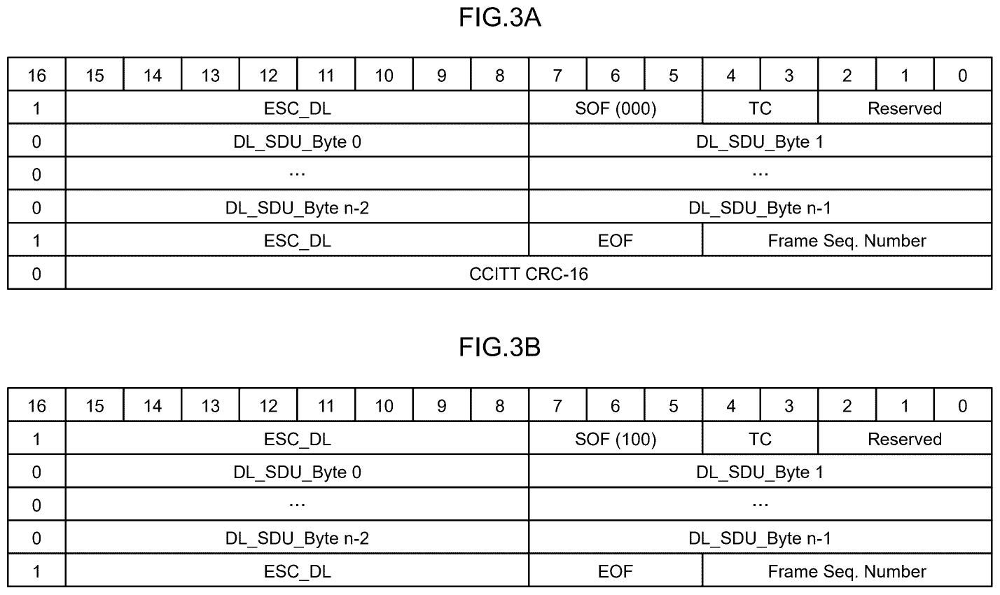

The DL layer 12 may generate the data frame DF of the format as illustrated in FIG. 3A as a data frame DF1 corresponding to the non-TFS mode.

The data frame DF illustrated in FIG. 3A includes an ESC_DL field, an SOF field, a TC field, a Reserved field, a DL_SDU_Byte 0 field to DL_SDU_Byten-1 field, an ESD_DL field, an EOF field, a Frame_Seq. _Number field, and a CCITT_CRC-16 field.

In the SOF field, “000” indicating that the type of data frame DF is a data frame corresponding to the non-TFS mode is stored. The SOF field may have a three-bit length.

In the CCITT_CRC-16 field, the error detection code CRC2 used in the DL layer 12 is stored. The CCITT_CRC-16 field may have 16 bits.

In FIG. 2, the SOF field is written as “SOF”, the CCITT_CRC-16 field is written as “DL CRC”, and other portions are written as “data”.

As illustrated in FIG. 2, the DL layer 12 starts to generate a data frame DF1 corresponding to the non-TFS mode, and starts to supply the data frame DF1 to the PA layer 13. The PA layer 13 converts the data frame DF1 to the format of the PA layer.

From timing t1 to t2, the PA layer 13 provides up to a portion from the head of the data frame DF1 to the PHY 14, and the PHY 14 transmits the same to the device 20 via the communication line 31. The PA layer 13 supplies a transmission stop request to the DL layer 12 as a preparation before switching to the TFS mode, and the DL layer 12 temporarily suspends the transmission of the data frame DF1 according to the transmission stop request. The PA layer 13 temporarily suspends the transmission of the data frame DF1 to the PHY 14. The DL layer 12 supplies a transmission stop completion notification to the PA layer 13 as a notification of acceptance of switching to the TFS mode.

At timing t3, the PA layer 13 transitions the TFS mode status signal from the non-active level to the active level in response to the transmission stop completion notification. The PA layer 13 starts to supply the TFS mode status signal in the active level to the DL layer 12. The DL layer 12 and the PA layer 13 respectively starts to operate in the TFS mode.

Along therewith, the PA layer 13 resumes the transmission of the data frame DF1 and supplies the transmission resume request to the DL layer 12. The DL layer 12 resumes the transmission of the data frame DF1 in response to the transmission resume request. Although the mode has been switched to the TFS mode, the data frame DF1 of the non-TFS mode remains, and thus the DL layer 12 keeps starting to supply the remaining portion of the data frame DF1 to the PA layer 13. The PA layer 13 starts to convert the data frame DF1 to TFS#1 according to the TFS mode.

At timing t4, the DL layer 12 generates “DL CRC” using “data” in the data frame DF1 and starts to include it as a part of the data frame DF1 according to the SOF being “000”.

For example, the DL layer 12 may generate “DL CRC” by applying a polynomial X¹⁶+X¹²+X⁵+X⁰ to the “data” and coding the “data”. The power of X in the polynomial indicates the bit position, and X indicates the bit value at the bit position.

The DL layer 12 supplies the data frame DF1 to the PA layer 13. The PA layer 13 includes the “data” and the “DL CRC”in the TFS#1.

At timing t5, the PA layer 13 generates the “TFS CRC” using the “data” and the “DL CRC” in the TFS#1 and starts to include it as a part of the TFS#1.

From timing t3 to t6, the PA layer 13 provides the TFS#1 to the PHY 14, and the PHY 14 transmits the same to the device 20 via the communication line 31.

At timing t6, the DL layer 12 starts to provide a data frame DF2 corresponding to the TFS mode based on the transmission information.

The DL layer 12 may generate the data frame DF of the format as illustrated in FIG. 3B as the data frame DF2 corresponding to the TFS mode.

The data frame DF illustrated in FIG. 3B is different from the data frame DF illustrated in FIG. 3A in the content of the SOF field, and is different from the data frame DF illustrated in FIG. 3A in that the CCITT_CRC-16 field is omitted.

The SOF field stores “100” indicating that the type of data frame DF is a data frame corresponding to the TFS mode. The SOF field may have a three-bit length.

In the data frame DF illustrated in FIG. 3B, the CCITT_CRC-16 field (“DL CRC” in FIG. 2) is omitted, but since the PA layer 13 generates the “TFS CRC” as an error detection code, error detection can be performed on the reception side.

At timing t6 illustrated in FIG. 2, the PA layer 13 starts to convert the data frame DF2 to TFS#2 according to the TFS mode.

From timing t6 to t7, the DL layer 12 supplies up to a portion “SOF, data” from the head of the data frame DF2 to the PA layer 13. The PA layer 13 includes the “SOF, data” in the TFS#2. The PA layer 13 generates the “TFS CRC” using the “SOF, data” in the TFS#2 and includes it as a part of the TFS#2.

From timing t6 to t8, the PA layer 13 provides the TFS#2 to the PHY 14, and the PHY 14 transmits the same to the device 20 via the communication line 31.

The DL layer 12 supplies the remaining portion “data” in the data frame DF2. At this time, the DL layer 12 does not supply the “DL CRC” according to the SOF being “100”. The DL layer 12 supplies the remaining portion “data” in the data frame DF2 to the PA layer 13. The PA layer 13 includes the remaining portion “data” in the data frame DF2 in the TFS#3.

At timing t9, the PA layer 13 supplies the transmission stop request to the DL layer 12 as a request for switching to the non-TFS mode. The DL layer 12 starts to generate a data frame DF3 corresponding to the non-TFS mode in accordance with the transmission stop request. The DL layer 12 supplies the transmission stop completion notification to the PA layer 13 as a notification of acceptance for switching to the non-TFS mode.

From timing t9 to t10, the DL layer 12 supplies a portion “SOF, data” from the head of the data frame DF3 to the PA layer 13. The PA layer 13 includes the “SOF, data” in the TFS#3. At timing t10, the PA layer 13 generates the “TFS CRC” using both the remaining portion “data” in the data frame DF2 in the TFS#3 and the portion “SOF, data” from the head of the DF3, and starts to include it as a part of the TFS#3.

From timing t8 to t11, the PA layer 13 provides the TFS#3 to the PHY 14, and the PHY 14 transmits the same to the device 20 via the communication line 31.

The DL layer 12 generates the remaining portion “data” in the data frame DF3. From timing t10 to t12, the DL layer 12 supplies the remaining portion “data” in the data frame DF2 to the PA layer 13. The PA layer 13 includes the remaining portion “data” in the data frame DF3 in the TFS#4.

At timing t13, the PA layer 13 generates the “TFS CRC” using the “data” in the TFS#4, and starts to include it as a part of the TFS#4.

From timing t11 to t14, the PA layer 13 provides the TFS#4 to the PHY 14, and the PHY 14 transmits the same to the device 20 via the communication line 31.

At timing t14, the PA layer 13 supplies the transmission stop request to the DL layer 12 as a preparation before switching to the non-TFS mode, and the DL layer 12 temporarily suspends the transmission of the data frame DF3 according to the transmission stop request. The DL layer 12 supplies the transmission stop completion notification to the PA layer 13 as a notification of acceptance for switching to the non-TFS mode.

The PA layer 13 transitions the TFS mode status signal from the active level to the non-active level according to the transmission stop completion notification. The PA layer 13 starts to supply the TFS mode status signal in the non-active level to the DL layer 12. The DL layer 12 and the PA layer 13 each start to operate in the non-TFS mode.

At timing t15, the PA layer 13 supplies the transmission resume request to the DL layer 12. The DL layer 12 resumes the transmission of the data frame DF3 according to the transmission resume request. The DL layer 12 generates “DL CRC” using the “data” in the data frame DF3 as a remaining portion of the data frame DF3 according to the SOF being “000”. The DL layer 12 supplies the remaining portion “DL CRC” of the data frame DF3 to the PA layer 13. The PA layer 13 provides the remaining portion “DL CRC” of the data frame DF3, and the PHY 14 transmits the same to the device 20 via the communication line 31.

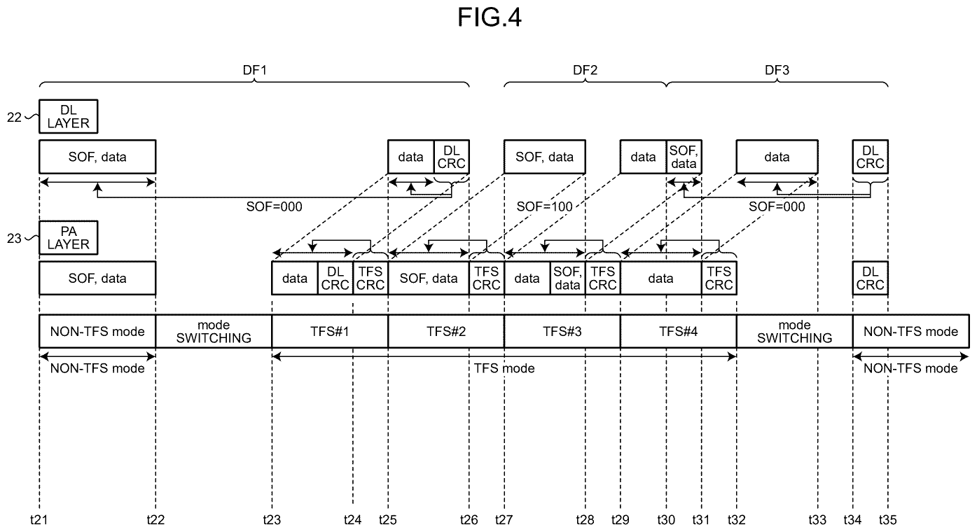

Next, an operation of a device on the reception side will be described using FIG. 4. In FIG. 4, a case where the device on the reception side is the device 20 will be exemplified. In FIG. 4, the operations of the DL layer 22 and the PA layer 23 will be mainly described.

At timing t21, the DL layer 22 and the PA layer 23 each operate in the non-TFS mode. The PA layer 23 starts to receive one portion “SOF, data” from the head of the data frame DF1 from the device 10 via the communication line 31 and the PHY 24.

From timing t21 to t22, the PA layer 23 supplies the one portion “SOF, data” from the head of the data frame DF1 to the DL layer 22. The DL layer 22 holds the one portion “SOF, data”from the head of the data frame DF1. At this time, the DL layer 22 recognizes that the data frame DF1 is a data frame corresponding to the non-TFS mode in accordance with the SOF being “000”.

At timing t23, the PA layer 23 receives the TFS#1 from the device 10 via the communication line 31 and the PHY layer 21. In accordance therewith, the PA layer 23 switches the communication mode from the non-TFS mode to the TFS mode.

At timing t25, the PA layer 23 performs error detection using the “TFS CRC” on the “data” and the “DL CRC” included in the TFS#1, confirms whether the TFS#1 has been correctly received, and supplies the confirmation result to the controller 21 via the DL layer 22.

After the error detection is completed, the PA layer 23 starts to supply the “data” and the “DL CRC” included in the TFS#1 to the DL layer 22.

The PA layer 23 receives the TFS#2 from the device 10 via the communication line 31 and the PHY layer 21.

At timing t26, the DL layer 22 performs error detection using the “DL CRC” on the held “SOF, data” and the supplied “data”, and confirms whether the data frame DF1 has been correctly received.

For example, the DL layer 22 performs division of the polynomial X¹⁶+X¹²+X¹⁵+X⁰ having 2 as the law on the “SOF, data” and the “data”, and confirms that the data frame DF1 has been correctly received if the remainder is zero. The DL layer 22 confirms that the data frame DF1 has not been correctly received if the remainder is not zero.

The DL layer 22 supplies the confirmation result to the controller 21.

Along therewith, the DL layer 22 configures the data frame DF1 including the “SOF, data”, the “data”, and the “DL CRC”. The DL layer 22 generates reception information corresponding to the non-TFS mode based on the data frame DF1, and supplies the reception information to the controller 21.

Note that when it is confirmed that the data frame DF1 failed to be correctly received, the controller 21 may discard the reception information, and request retransmission of the data frame DF1 from the device 10, which is a transmission source.

At timing t27, the PA layer 23 performs error detection using the “TFS CRC” with respect to the “SOF, data” included in the TFS#2, confirms whether the TFS#2 has been correctly received, and supplies the confirmation result to the controller 21 via the DL layer 22.

After the error detection is completed, the PA layer 23 starts to supply the “SOF, data” included in the TFS#2 to the DL layer 22.

The PA layer 23 receives the TFS#3 from the device 10 via the communication line 31 and the PHY layer 21.

At timing t29, the PA layer 23 performs error detection using the “TFS CRC” with respect to the “data” and the “SOF, data” included in the TFS#3, confirms whether the TFS#3 has been correctly received, and supplies the confirmation result to the controller 21 via the DL layer 22.

After the error detection is completed, the PA layer 23 starts to supply the “data” and the “SOF, data” included in the TFS#3 to the DL layer 22.

The DL layer 22 holds the “SOF, data” supplied from the PA layer 23 as a portion from the head of the data frame DF2. The DL layer 22 recognizes that the data frame DF2 is a data frame corresponding to the TFS mode in accordance with the SOF being “100”.

The PA layer 23 receives the TFS#4 from the device 10 via the communication line 31 and the PHY layer 21.

At timing t30, the DL layer 22 holds the “data” supplied from the PA layer 23. The DL layer 22 configures the data frame DF2 including the held “SOF, data” and the “data”. The DL layer 22 generates reception information corresponding to the TFS mode based on the data frame DF2, and supplies the reception information to the controller 21.

From timing t30 to t31, the PA layer 23 supplies the “data”included in the TFS#4 to the DL layer 22.

The DL layer 22 recognizes that the data frame DF3 is a data frame corresponding to the non-TFS mode in accordance with the SOF being “000” in the “SOF, data” supplied from the PA layer 23.

At timing t32, the PA layer 23 performs error detection using the “TFS CRC” with respect to the “data” included in the TFS#4, confirms whether the TFS#4 has been correctly received, and supplies the confirmation result to the controller 21 via the DL layer 22.

After the error detection is completed, the PA layer 23 starts to supply the “data” included in the TFS#4 to the DL layer 22.

At timing t33, the DL layer 22 holds a portion “SOF, data” from the head of the data frame DF3 and the “data”.

From timing t34 to t35, the PA layer 23 receives the remaining portion “DL CRC” of the data frame DF3 from the device 10 via the communication line 31 and the PHY layer 21. The PA layer 23 supplies the remaining portion “DL CRC”of the data frame DF3 to the DL layer 22.

At timing t35, the DL layer 22 performs error detection using the “DL CRC” with respect to the held “SOF, data” and the “data”, confirms whether the data frame DF3 has been correctly received, and supplies the confirmation result to the controller 21. Along therewith, the DL layer 22 configures the data frame DF3 including the “SOF, data”, the “data”, and the “DL CRC”. The DL layer 22 generates reception information corresponding to the non-TFS mode based on the data frame DF3, and supplies the reception information to the controller 21.

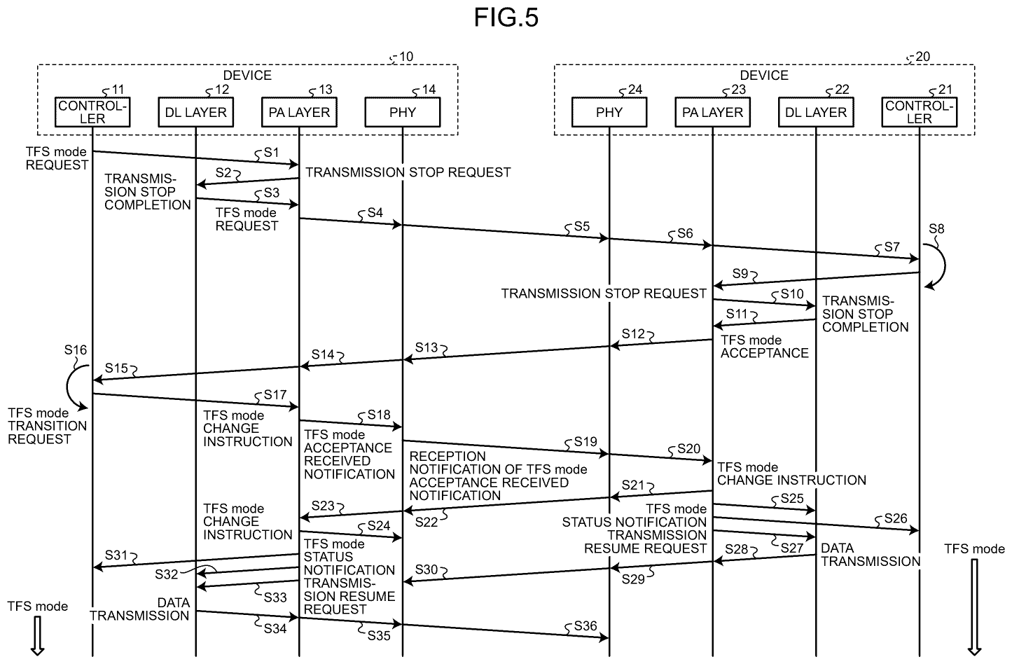

Next, a sequence of operations when the device 10 and the device 20 transition from the non-TFS mode to the TFS mode in the system 1 will be described using FIG. 5. FIG. 5 is a sequence diagram illustrating the operation of the system 1.

In the device 10, when the controller 11 supplies a TFS mode request to the PA layer 13 (S1), the PA layer 13 supplies a transmission stop request to the DL layer 12 (S2). The DL layer 12 stops the transmission of the data frame DF, and notifies the transmission stop completion to the PA layer 13 (S3). When the PA layer 13 supplies the TFS mode request to the PHY 14 (S4), the PHY 14 transmits the TFS mode request to the device 20 (S5).

In the device 20, upon receiving the TFS mode request, the PHY 24 supplies the TFS mode request to the PA layer 23 (S6). The PA layer 23 supplies the TFS mode request to the controller 21 (S7). Upon receiving the TFS mode request (S8), the controller 21 supplies the transmission stop request to the PA layer 23 (S9). The PA layer 23 supplies the transmission stop request to the DL layer 22 (S10). The DL layer 22 stops the transmission of the data frame DF, and notifies the transmission stop completion to the PA layer 23 (S11). When the PA layer 23 supplies the TFS mode acceptance to the PHY 24 (S12), the PHY 24 transmits the TFS mode acceptance to the device 10 (S13).

In the device 10, upon receiving the TFS mode acceptance, the PHY 14 supplies the TFS mode acceptance to the PA layer 13 (S14). The PA layer 13 supplies the TFS mode acceptance to the controller 11 (S15). The controller 11 receives the TFS mode acceptance (S16), and supplies a TFS mode transition request to the PA layer 13 (S17). When the PA layer 13 supplies a TFS mode change instruction to the PHY 14 (S18), the PHY 24 transmits a TFS mode acceptance received notification to the device 20 (S19).

In the device 20, upon receiving the TFS mode acceptance received notification, the PHY 24 supplies the TFS mode acceptance received notification to the PA layer 23 (S20). When the PA layer 23 supplies the TFS mode change instruction to the PHY 24 (S21), the PHY 24 transmits the reception notification of the TFS mode acceptance received notification to the device 10 (S22).

In the device 10, upon receiving the reception notification of the TFS mode acceptance received notification, the PHY 14 supplies the reception notification of the TFS mode acceptance received notification to the PA layer 13 (S23). The PA layer 13 supplies the TFS mode change instruction to the PHY 14 (S24).

In parallel therewith, in the device 20, the PA layer 23 supplies a TFS mode status notification to the DL layer 22 (S25), and supplies the TFS mode status notification to the controller 21 (S26). When the PA layer 23 supplies the transmission resume request to the DL layer 22 (S27), the DL layer 22 resumes data transmission. The PA layer 23 and the DL layer 22 thus switch the communication mode from the non-TFS mode to the TFS mode. The DL layer 22 generates a data frame DF corresponding to the TFS mode, and supplies the same to the PA layer 23 (S28). The PA layer 23 generates the TFS from the data frame DF, and supplies the same to the PHY 24 according to the TFS mode (S29). The PHY 24 transmits the TFS to the device 10 (S30).

In parallel therewith, in the device 10, the PA layer 13 supplies the TFS mode status notification to the controller 11 (S31), and supplies the TFS mode status notification to the DL layer 12 (S32). When the PA layer 13 supplies the transmission resume request to the DL layer 12 (S33), the DL layer 12 resumes data transmission. The PA layer 13 and the DL layer 12 thus switch the communication mode from the non-TFS mode to the TFS mode. The DL layer 12 supplies the data frame DF corresponding to the TFS mode to the PA layer 13 (S34). The PA layer 13 generates the TFS from the data frame DF and supplies the same to the PHY 14 according to the TFS mode (S35). The PHY 14 transmits the TFS to the device 20 (S36).

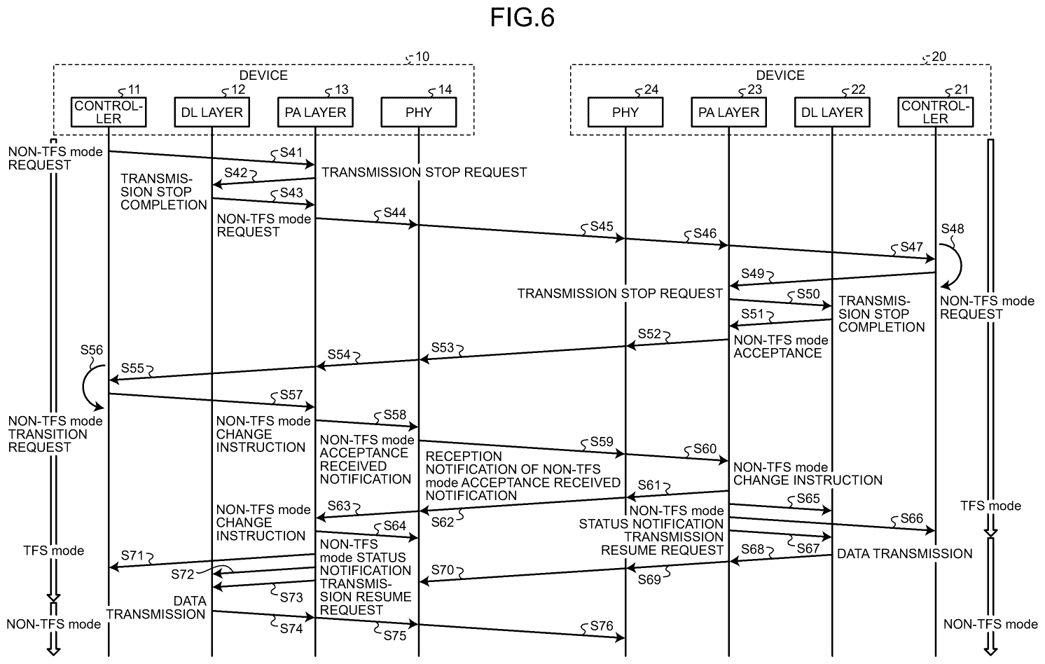

Next, a sequence of operations when the device 10 and the device 20 transition from the TFS mode to the non-TFS mode in the system 1 will be described using FIG. 6. FIG. 6 is a sequence diagram illustrating the operation of the system 1.

In the device 10, when the controller 11 supplies a non-TFS mode request to the PA layer 13 (S41), the PA layer 13 supplies a transmission stop request to the DL layer 12 (S42). The DL layer 12 stops the transmission of the data frame DF, and notifies the transmission stop completion to the PA layer 13 (S43). When the PA layer 13 supplies the non-TFS mode request to the PHY 14 (S44), the PHY 14 transmits the non-TFS mode request to the device 20 (S45).

In the device 20, when receiving the non-TFS mode request, the PHY 24 supplies the non-TFS mode request to the PA layer 23 (S46). The PA layer 23 supplies the non-TFS mode request to the controller 21 (S47). The controller 21 receives the non-TFS mode request (S48), and supplies the transmission stop request to the PA layer 23 (S49). The PA layer 23 supplies the transmission stop request to the DL layer 22 (S50). The DL layer 22 stops the transmission of the data frame DF, and notifies the transmission stop completion to the PA layer 23 (S51). When the PA layer 23 supplies the non-TFS mode acceptance to the PHY 24 (S52), the PHY 24 transmits the non-TFS mode acceptance to the device 10 (S53).

In the device 10, upon receiving the non-TFS mode acceptance, the PHY 14 supplies the non-TFS mode acceptance to the PA layer 13 (S54). The PA layer 13 supplies the non-TFS mode acceptance to the controller 11 (S55). The controller 11 receives the non-TFS mode acceptance (S56), and supplies the non-TFS mode transition request to the PA layer 13 (S57). When the PA layer 13 supplies the non-TFS mode change instruction to the PHY 14 (S58), the PHY 24 transmits the non-TFS mode acceptance received notification to the device 20 (S59).

In the device 20, upon receiving the non-TFS mode acceptance received notification, the PHY 24 supplies the non-TFS mode acceptance received notification to the PA layer 23 (S60). When the PA layer 23 supplies the non-TFS mode change instruction to the PHY 24 (S61), the PHY 24 transmits the reception notification of the TFS mode acceptance received notification to the device 10 (S62).

In the device 10, upon receiving the reception notification of the non-TFS mode acceptance received notification, the PHY 14 supplies the reception notification of the non-TFS mode acceptance received notification to the PA layer 13 (S63). The PA layer 13 supplies the non-TFS mode change instruction to the PHY 14 (S64).

In parallel therewith, in the device 20, the PA layer 23 supplies a non-TFS mode status notification to the DL layer 22 (S65), and supplies the non-TFS mode status notification to the controller 21 (S66). When the PA layer 23 supplies the transmission resume request to the DL layer 22 (S67), the DL layer 22 resumes data transmission. The PA layer 23 and the DL layer 22 thus switch the communication mode from the TFS mode to the non-TFS mode. The DL layer 22 generates a data frame DF corresponding to the non-TFS mode, and supplies the same to the PA layer 23 (S68). The PA layer 23 format converts from the data frame DF, and supplies the same to the PHY 24 according to the non-TFS mode (S69). The PHY 24 transmits the data frame DF to the device 10 (S70).

In parallel therewith, in the device 10, the PA layer 13 supplies the non-TFS mode status notification to the controller 21 (S71), and supplies the non-TFS mode status notification to the DL layer 22 (S72). When the PA layer 13 supplies the transmission resume request to the DL layer 12 (S73), the DL layer 12 resumes data transmission. The PA layer 13 and the DL layer 12 thus switch the communication mode from the TFS mode to the non-TFS mode. The DL layer 12 supplies the data frame DF corresponding to the non-TFS mode to the PA layer 13 (S74). The PA layer 13 format converts the data frame DF, and supplies the same to the PHY 14 according to the non-TFS mode (S75). The PHY 14 transmits the data frame DF to the device 20 (S76).

As described above, according to the first embodiment, in the communication method, in a case where all the data frames DF are transmitted in the TFS mode, the data frame DF is generated by adding the error detection code “TFS CRC” to the data without adding the error detection code “DL CRC” to the data. Thus, the transfer of the error detection code “DL CRC” can be omitted, whereby the data transfer efficiency can be improved.

### Second Embodiment

Next, a communication method according to a second embodiment will be described. Hereinafter, a portion different from the first embodiment will be mainly described.

In the first embodiment, a communication method in which generation of a data frame DF across multiple communication modes is permitted has been exemplified, but in the second embodiment, a communication method in which generation of a data frame DF across multiple communication modes is prohibited is exemplified.

In the system 1 illustrated in FIG. 1, when the communication mode is switched from the communication mode MD_A to the communication mode MD_B, the device 10 switches the operation of generating the data frame DF from an operation OP_A to an operation OP_B.

Each of the contents of the communication mode MD_A, the communication mode MD_B, the operation OP_A, and the operation OP_B is similar to that of the first embodiment. The communication mode MD_A is, for example, the non-TFS mode. The communication mode MD_B is, for example, the TFS mode.

When the communication mode is switched from the communication mode MD_B to the communication mode MD_A, the device 10 switches the operation of generating the data frame DF from the operation OP_B to the operation OP_A.

Similarly, when the communication mode is switched from the communication mode MD_A to the communication mode MD_B, the device 20 switches the operation of generating the data frame DF from the operation OP_A to the operation OP_B.

When the communication mode is switched from the communication mode MD_B to the communication mode MD_A, the device 20 switches the operation of generating the data frame DF from the operation OP_B to the operation OP_A.

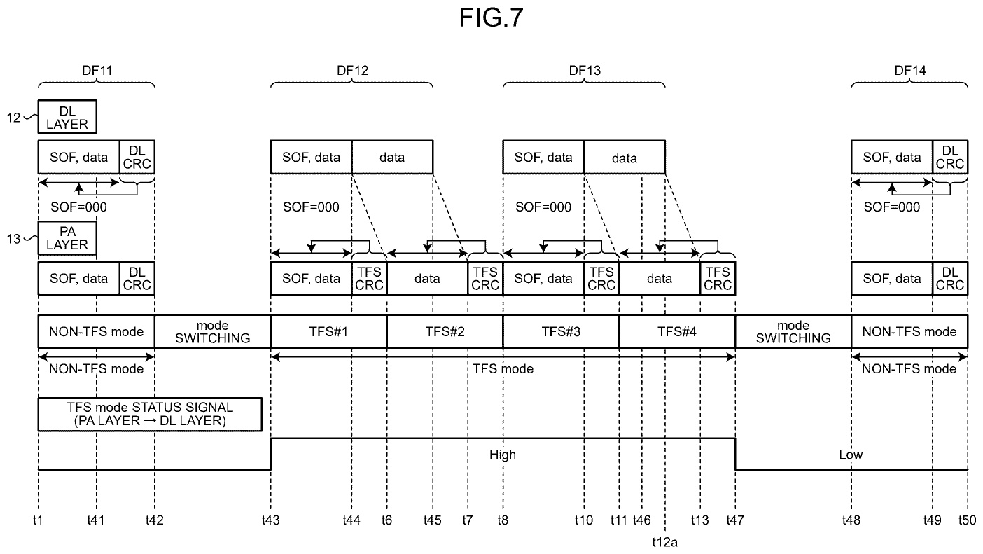

For example, the operation of the device on the transmission side is different from the first embodiment in the following point, as illustrated in FIG. 7. FIG. 7 is a diagram illustrating an operation of the device on the transmission side according to the second embodiment. In FIG. 7, a case where the device on the transmission side is the device 10 will be exemplified. In FIG. 7, the operations of the DL layer 12 and the PA layer 13 will be mainly described.

At timing t1, an operation similar to the first embodiment is performed, and thereafter, at timing t41, the PA layer 13 supplies the transmission stop request to the DL layer 12 as a preparation before switching to the TFS mode. The DL layer 12 concludes the “SOF, data” of the data frame DF11 according to the transmission stop request, generates the “DL CRC” using the “SOF, data” in the data frame DF11, and sets the same as the data frame DF11. The DL layer 12 supplies the transmission stop completion notification to the PA layer 13 as a notification of acceptance of switching to the TFS mode.

From timing t1 to t42, the DL layer 12 supplies the data frame DF11 to the PA layer 13. The PA layer 13 supplies the data frame DF11 to the PHY 14, and the PHY 14 transmits the same to the device 20 via the communication line 31.

At timing t43, the PA layer 13 transitions the TFS mode status signal from the non-active level to the active level according to the transmission stop completion notification. The PA layer 13 starts to supply the TFS mode status signal in the active level to the DL layer 12. The DL layer 12 and the PA layer 13 each start to operate in the TFS mode.

Along therewith, the DL layer 12 starts to generate a data frame DF12 corresponding to the TFS mode based on the transmission information. The DL layer 12 starts to generate the data frame DF12 in a format not including the “DL CRC”.

The DL layer 12 may generate a data frame DF of a format in which the SOF field in the format as illustrated in FIG. 3B is replaced with “000”, as the data frame DF12 corresponding to the TFS mode. The DL layer 12 may generate a data frame DF of a format in which the SOF field is “000”and the CCITT_CRC-16 field is omitted.

Note that the values of the SOF field are the same between the data frame DF corresponding to the TFS mode and the data frame DF corresponding to the non-TFS mode, but the DL layer 12 can recognize that the current communication mode is the TFS mode by confirming the TFS mode status signal in the active level.

The DL layer 12 starts to supply the data frame DF12 to the PA layer 13. The PA layer 13 starts to convert the data frame DF12 to TFS#1 according to the TFS mode. The PA layer 13 includes a portion “SOF, data” from the head of the data frame DF12 in the TFS#1.

At timing t44, the PA layer 13 starts to generate the “TFS CRC” using the “SOF, data” in the TFS#1, and starts to include it as a part of the TFS#1.

From timing t43 to t6, the PA layer 13 provides the TFS#1 to the PHY14, and the PHY 14 transmits the same to the device 20 via the communication line 31.

From timing t44 to t45, the DL layer 12 supplies the remaining portion “data” in the data frame DF12 to the PA layer 13. The PA layer 13 includes the “data” in the TFS#2.

At timing t7, the PA layer 13 starts to generate the “TFS CRC” using the “data” in the TFS#2, and starts to include it as a part of the TFS#2.

From timing t6 to t8, the PA layer 13 provides the TFS#2 to the PHY 14, and the PHY 14 transmits the same to the device 20 via the communication line 31.

At timing t8, the DL layer 12 starts to generate a data frame DF13 corresponding to the TFS mode based on the transmission information. The DL layer 12 starts to generate the data frame DF12 in a format not including the “DL CRC”.

The DL layer 12 may generate a data frame DF of a format in which the SOF in the format as illustrated in FIG. 3B is replaced with “000”, as the data frame DF13 corresponding to the TFS mode.

From timing t8 to t10, the DL layer 12 supplies up to a portion “SOF, data” from the head of the data frame DF13 to the PA layer 13. The PA layer 13 includes the “SOF, data”in the TFS#3.

At timing t10, the PA layer 13 starts to generate the “TFS CRC” using the “SOF, data” in the TFS#3, and starts to include it as a part of the TFS#3.

From timing t8 to t11, the PA layer 13 provides the TFS#3 to the PHY 14, and the PHY 14 transmits the same to the device 20 via the communication line 31.

From timing t10 to t12a, the DL layer 12 supplies the remaining portion “data” in the data frame DF12 to the PA layer 13. The PA layer 13 includes the “data” in the TFS#4.

At timing t13, the PA layer 13 starts to generate the “TFS CRC” using the “data” in the TFS#4, and starts to include it as a part of the TFS#4.

At timing t46, the PA layer 13 supplies the transmission stop request to the DL layer 12 as a request for switching to the non-TFS mode. The DL layer 12 concludes the remaining portion “data” of the data frame DF13 according to the transmission stop request. The DL layer 12 supplies the transmission stop completion notification to the PA layer 13 as a notification of acceptance of switching to the non-TFS mode.

From timing t11 to t47, the PA layer 13 supplies the TFS#4 to the PHY 14, and the PHY 14 transmits the same to the device 20 via the communication line 31.

The PA layer 13 transitions the TFS mode status signal from the active level to the non-active level according to the transmission stop completion notification. The PA layer 13 starts to supply the TFS mode status signal in the non-active level to the DL layer 12. The DL layer 12 and the PA layer 13 each start to operate in the non-TFS mode.

At timing t48, the PA layer 13 supplies the transmission resume request to the DL layer 12. The DL layer 12 starts to generate a data frame DF14 corresponding to the non-TFS mode based on the transmission information in accordance with the transmission resume request.

The DL layer 12 may generate a data frame DF of a format as illustrated in FIG. 3A as the data frame DF14 corresponding to the non-TFS mode.

At timing t49, the DL layer 12 concludes the “SOF, data” of the data frame DF14, generates the “DL CRC” using the “SOF, data” in the data frame DF14, and starts to include it as a part of the data frame DF14.

From timing t48 to t50, the DL layer 12 supplies the data frame DF14 to the PA layer 13. The PA layer 13 supplies the data frame DF14 to the PHY 14, and the PHY 14 transmits the same to the device 20 via the communication line 31.

As illustrated in FIG. 7, the data frames DF11 and DF14 corresponding to the non-TFS mode are both transmitted within a period of operating in the non-TFS mode. The data frames DF12 and DF13 corresponding to the TFS mode are both transmitted within a period of operating in the TFS mode. Thus, it can be seen that the operation in which the generation of a data frame DF across multiple communication modes is prohibited is performed.

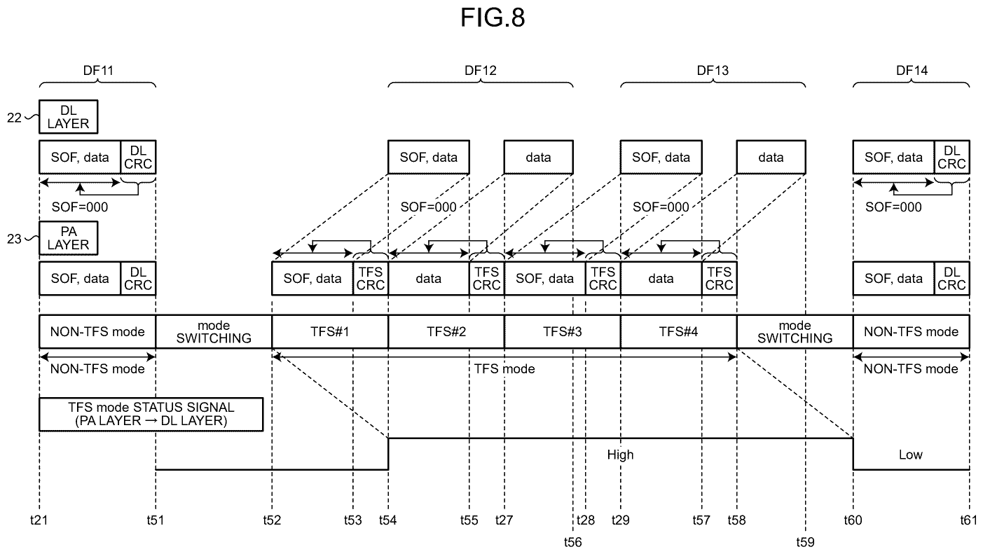

As illustrated in FIG. 8, the operation of the device on the reception side is different from the first embodiment in the following point. FIG. 8 is a diagram illustrating an operation of the device on the reception side according to the second embodiment. In FIG. 8, a case where the device on the reception side is the device 20 is exemplified. In FIG. 8, the operations of the DL layer 22 and the PA layer 23 are mainly described.

From timing t21 to t51, the PA layer 23 receives the data frame DF11, and provides the same to the DL layer 22. The DL layer 22 recognizes that the data frame DF11 has concluded according to the reception of the “DL CRC”.

The DL layer 22 performs error detection using the “DL CRC” with respect to the “SOF, data”, and confirms whether the data frame DF11 has been correctly received. The DL layer 22 supplies the confirmation result to the controller 21.

At timing t52, the PA layer 23 transitions the TFS mode status signal from the non-active level to the active level. The PA layer 23 starts to supply the TFS mode status signal in the active level to the DL layer 22. The PA layer 23 starts to operate in the TFS mode.

Along therewith, the PA layer 23 receives the TFS#1 from the device 10 via the communication line 31 and the PHY 24.

At timing t54, the DL layer 22 starts to receive the TFS mode status signal in the active level from the PA layer 23. The DL layer 22 starts to operate in the TFS mode.

At timing t54, the PA layer 23 performs error detection using the “TFS CRC” with respect to the “SOF, data” included in the TFS#1, confirms whether the TFS#1 has been correctly received, and supplies the confirmation result to the controller 21 via the DL layer 22.

After the error detection is completed, the PA layer 23 starts to supply the “SOF, data” of the data frame DF12 to the DL layer 22.

The PA layer 23 receives the TFS#2 from the device 10 via the communication line 31 and the PHY 24.

At timing t27, the PA layer 23 performs error detection using the “TFS CRC” with respect to the “SOF, data” included in the TFS#2, confirms whether the TFS#2 has been correctly received, and supplies the confirmation result to the controller 21 via the DL layer 22.

At timing t27, the PA layer 23 starts to supply the “data”included in the TFS#2 to the DL layer 22.

At timing t56, the DL layer 22 holds the “data” supplied from the PA layer 23. The DL layer 22 configures the data frame DF12 including the held “SOF, data” and the “data”. The DL layer 22 configures the data frame DF12 with a format not including the “DL CRC”. The DL layer 22 generates reception information corresponding to the TFS mode based on the data frame DF12, and supplies the reception information to the controller 21.

After an operation similar to the first embodiment is performed at timing t28 to t29, the DL layer 22 holds the “SOF, data” supplied from the PA layer 23 at timing t57.

The PA layer 23 supplies the “data” included in the TFS#4 to the DL layer 22.

At timing t58, the PA layer 23 performs error detection using the “TFS CRC” with respect to the “data” included in the TFS#4, confirms whether the TFS#4 has been correctly received, and supplies the confirmation result to the controller 21 via the DL layer 22.

At timing t60, the PA layer 23 transitions the TFS mode status signal from the active level to the non-active level. The PA layer 23 starts to supply the TFS mode status signal in the non-active level to the DL layer 22. The PA layer 23 starts to operate in the non-TFS mode.

From timing t58 to t59, the DL layer 22 receives the “data”of the data frame DF13 from the PA layer 23. The DL layer 22 recognizes that the data frame DF13 has concluded. The DL layer 22 configures the data frame DF13 including the held “SOF, data” and the “data”. The DL layer 22 configures the data frame DF13 with a format not including the “DL CRC”. The DL layer 22 generates reception information corresponding to the TFS mode based on the data frame DF13, and supplies the reception information to the controller 21.

At timing t60, the DL layer 22 starts to receive the TFS mode status signal in the non-active level from the PA layer 23. The DL layer 22 starts to operate in the non-TFS mode.

Along therewith, the PA layer 23 supplies a portion “SOF, data” from the head of the data frame DF14 to the DL layer 22.

At timing t61, the PA layer 23 receives the remaining portion “DL CRC” of the data frame DF14 from the device 10 via the communication line 31 and the PHY layer 21. The PA layer 23 supplies the data frame DF3 to the DL layer 22.

The DL layer 22 performs error detection using the “DL CRC” with respect to the held “SOF, data”, confirms whether the data frame DF14 has been correctly received, and supplies the confirmation result to the controller 21. Along therewith, the DL layer 22 configures the data frame DF14 including the “SOF, data” and the “DL CRC”. The DL layer 22 generates reception information corresponding to the non-TFS mode based on the data frame DF14, and supplies the reception information to the controller 21.

As illustrated in FIG. 8, the data frames DF11 and DF14 corresponding to the non-TFS mode are both received within a period of operating in the non-TFS mode. The data frames DF12 and DF13 corresponding to the TFS mode are both received within a period of operating in the TFS mode. Thus, it can be seen that the operation in which the generation of a data frame DF across multiple communication modes is prohibited is performed.

As described above, according to the second embodiment, in the communication method, in a case where generation of a data frame DF across multiple communication modes is prohibited and all the data frames DF are transmitted in the TFS mode, the data frame DF is generated by adding the error detection code “TFS CRC” to the data without adding the error detection code “DL CRC” to the data. Thus, the transfer of the error detection code “DL CRC” can be omitted, whereby the data transfer efficiency can be improved.

Note that, as a modified example of the second embodiment, the control of switching of the multiple communication modes may be performed using a value of the SOF field in the format of the data frame DF instead of being performed at the level of the TFS mode status signal.

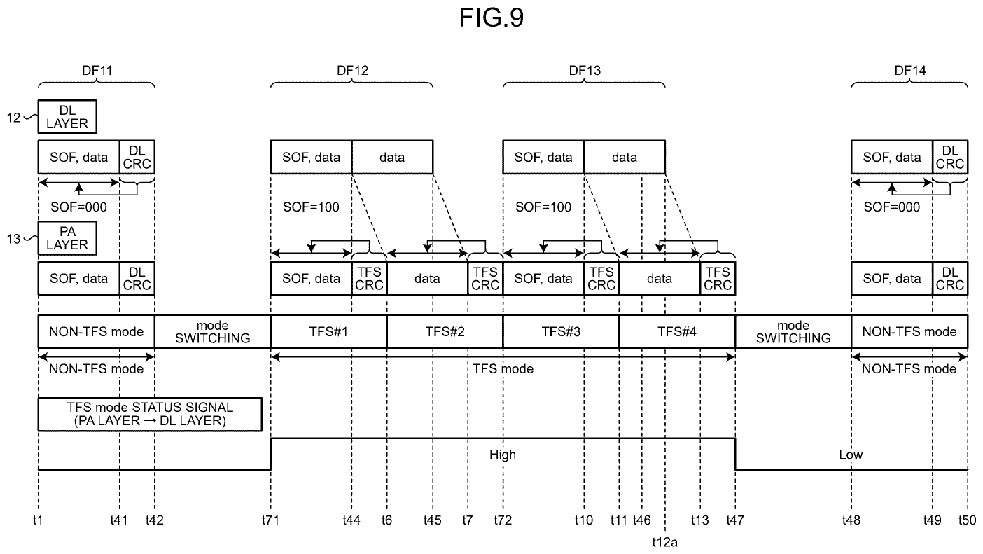

In this case, as illustrated in FIG. 9, the operation of the device on the transmission side is different from the second embodiment in the following point. FIG. 9 is a diagram illustrating the operation of the device on the transmission side according to a modified example of the second embodiment. In FIG. 9, a case where the device on the transmission side is the device 10 is exemplified. In FIG. 9, the operations of the DL layer 12 and the PA layer 13 will be mainly described.

At timing t1 to t42, an operation similar to the second embodiment is performed, and thereafter, at timing t71, the PA layer 13 transitions the TFS mode status signal from the non-active level to the active level. The PA layer 13 starts to supply the TFS mode status signal in the active level to the DL layer 12. The DL layer 12 and the PA layer 13 respectively start to operate in the TFS mode.

Along therewith, the DL layer 12 starts to generate the data frame DF12 corresponding to the TFS mode based on the transmission information. The DL layer 12 may start to generate the data frame DF12 in a format not including the “DL CRC”.

The DL layer 12 may generate the data frame DF in the format as illustrated in FIG. 3B as the data frame DF2 corresponding to the TFS mode. The DL layer 12 may generate the data frame DF in the format in which the SOF field is “100”.

The DL layer 12 starts to supply the data frame DF12 to the PA layer 13. The PA layer 13 starts to convert the data frame DF12 to the TFS#1 according to the TFS mode.

At timing t44 to t7, an operation similar to the second embodiment is performed, and thereafter, at timing t72, the DL layer 12 starts to generate the data frame DF12 corresponding to the TFS mode based on the transmission information. The DL layer 12 starts to generate the data frame DF12 in a format not including the “DL CRC”.

The DL layer 12 may generate the data frame DF in the format as illustrated in FIG. 3B as the data frame DF2 corresponding to the TFS mode. The DL layer 12 may generate the data frame DF in the format in which the SOF field is “100”.

After timing t10, an operation similar to the second embodiment is performed.

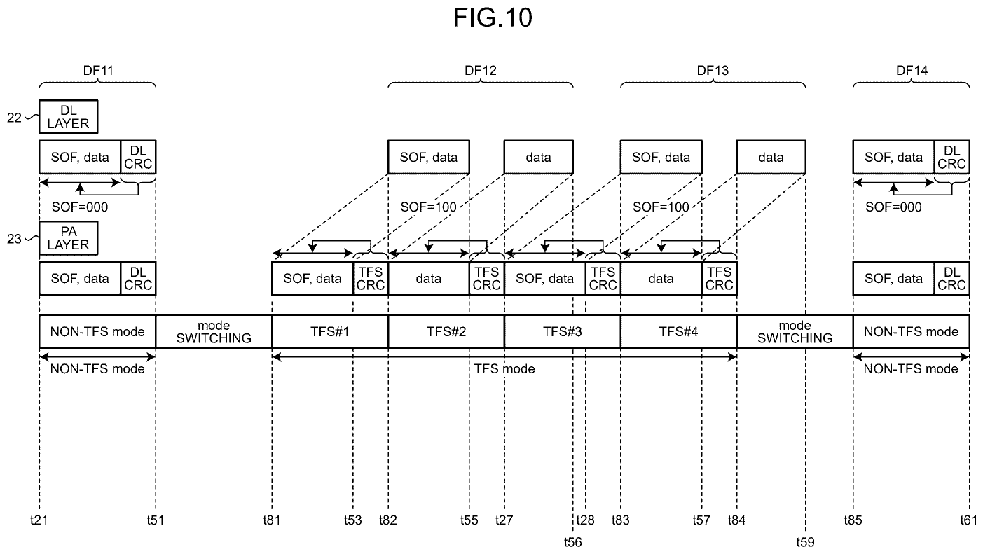

As illustrated in FIG. 10, the operation of the device on the reception side is different from the second embodiment in the following point. FIG. 10 is a diagram illustrating the operation of the device on the reception side according to a modified example of the second embodiment. In FIG. 10, a case where the device on the reception side is the device 20 is exemplified. In FIG. 10, the operations of the DL layer 22 and the PA layer 23 will be mainly described.

At timing t21 to t51, an operation similar to the second embodiment is performed, and thereafter, at timing t81, the PA layer 23 receives the TFS#1 from the device 10 via the communication line 31 and the PHY layer 21.

At timing t53, an operation similar to the second embodiment is performed, and thereafter, at timing t82, the DL layer 22 starts to receive the “SOF, data” of the data frame DF12 from the PA layer 23. The DL layer 22 starts to operate in the TFS mode according to the SOF of the data frame DF12 being “100”.

Along therewith, the PA layer 23 performs error detection using the “TFS CRC” with respect to the “SOF, data” included in the TFS#1, confirms whether the TFS#1 has been correctly received, and supplies the confirmation result to the controller 21 via the DL layer 22.

The PA layer 23 receives the TFS#2 from the device 10 via the communication line 31 and the PHY layer 21.

At timing t55 to t28, an operation similar to the second embodiment is performed, and thereafter, at timing t83, the PA layer 23 performs error detection using the “TFS CRC” with respect to the “SOF, data” included in the TFS#3, confirms whether the TFS#3 has been correctly received, and supplies the confirmation result to the controller 21 via the DL layer 22.

The PA layer 23 receives the TFS#4 from the device 10 via the communication line 31 and the PHY layer 21.

Along therewith, the DL layer 22 starts to receive the “SOF, data” of the data frame DF13 from the PA layer 23. The DL layer 22 continues to operate in the TFS mode according to the SOF of the data frame DF12 being “100”.

At timing t57, an operation similar to the second embodiment is performed, and thereafter, at timing t84, the PA layer 23 performs error detection using the “TFS CRC” with respect to the “data” included in the TFS#4, confirms whether the TFS#4 has been correctly received, and supplies the confirmation result to the controller 21 via the DL layer 22.

Along therewith, the PA layer 23 starts to operate in the non-TFS mode.

The PA layer 23 supplies a reception stop request to the DL layer 22.

At timing t59, an operation similar to the second embodiment is performed, and thereafter, at timing t85, the PA layer 23 supplies the “SOF, data” of the data frame DF14 and the error detection code “DL CRC”to the DL layer 22.

The DL layer 22 starts to receive the “SOF, data” of the data frame DF14 from the PA layer 23. The DL layer 22 starts to operate in the non-TFS mode according to the SOF of the data frame DF14 being “000”.

Thereafter, at timing t61, an operation similar to the second embodiment is performed.

In such a communication method as well, generation of the data frame DF across multiple communication modes are prohibited, and when all the data frames DF are transmitted in the TFS mode, the data frame DF is generated by adding the error detection code “TFS CRC” to the data without adding the error detection code “DL CRC” to the data. Thus, the transfer of the error detection code “DL CRC” can be omitted, whereby the data transfer efficiency can be improved.

### Third Embodiment

Next, a communication method according to a third embodiment will be described. Hereinafter, a portion different from the first embodiment and the second embodiment will be mainly described.

In the first embodiment and the second embodiment, a format of a data frame DF in which the field of error detection code is omitted has been exemplified, but in the third embodiment, a format of a data frame DF in which the field of error detection code is replaced with AFC (Acknowledgement and Flow Control) information is exemplified.

In the system 1, the device 10 performs the operation OP_B when a condition CD_B is satisfied for the communication mode MD_B and the communication mode MD_A.

The communication mode MD_B uses the transmission unit TU_B. The transmission unit TU_B may have a fixed length. The communication mode MD_A uses the transmission unit TU_A. The transmission unit TU_A and the transmission unit TU_B may have a different data length. The transmission unit TU_A may have a variable length.

The condition CD_B may include that all the data frames DF are transmitted in the communication mode MD_A.

The operation OP_B is similar to the first embodiment in that the data frame DF is generated by adding the error detection code CRC_B to the data without adding the error detection code CRC_A to the data, but is different from the first embodiment in that the data frame DF is generated by adding AFC (Acknowledgement and Flow Control) information to the data in place of the error detection code CRC_A.

Similarly, the device 20 performs the operation OP_B when the condition CD_B is satisfied for the communication mode MD_B and the communication mode MD_A.

The operation OP_B is similar to the first embodiment in that the data frame DF is generated by adding the error detection code CRC_B to the data without adding the error detection code CRC_A to the data, but is different from the first embodiment in that the data frame DF is generated by adding AFC (Acknowledgement and Flow Control) information to the data in place of the error detection code CRC_A.

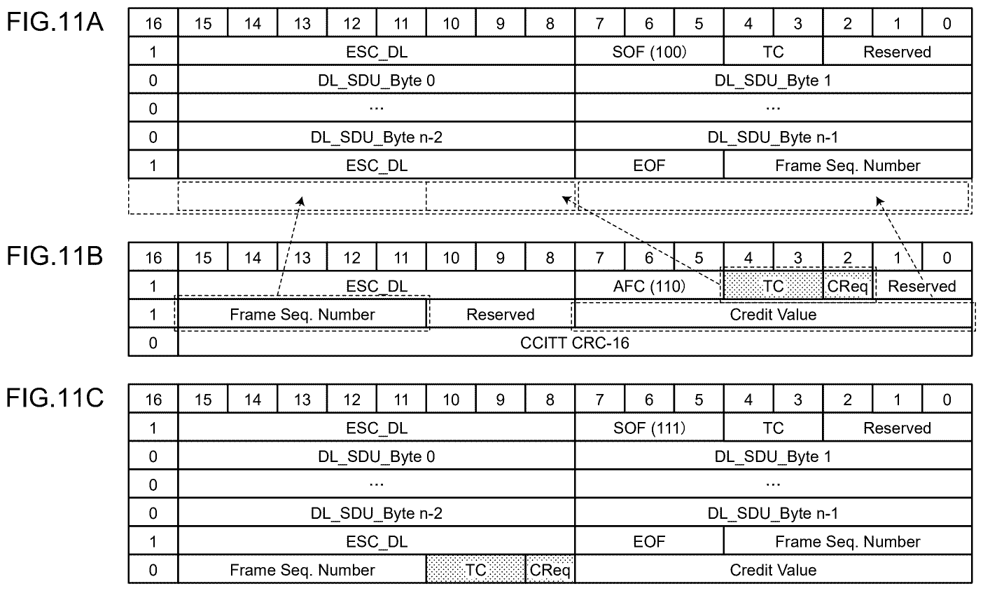

For example, in the first embodiment, the format of the data frame DF illustrated in FIG. 3B has been exemplified as the data frame DF corresponding to the TFS mode, but the CCITT_CRC-16 field to be omitted can be assumed as the Reserved field of 16 bits, as illustrated with a dotted line in FIG. 11A.

On the other hand, in the communication between the device 10 and the device 20, the AFC frame as illustrated in FIG. 11B is also transmitted and received other than the data frame DF.

The AFC frame illustrated in FIG. 11B includes an ESC_DL field, an AFC field, TC field, a CReq field, a Reserved field, a Frame_Seq._Number field, a Reserved field, a Credit Value field, and a CCITT_CRC-16 field.

Among them, fields other than the Frame_Seq._Number field, the TC field, the CReq field, and the Credit Value field surrounded by a dotted line can be omitted. The total of the number of bits of the Frame_Seq._Number field, the TC field, the CReq field, and the Credit Value field surrounded by the dotted line is 16 bits, and is less than or equal to 16 bits.

As illustrated with an arrow of a dotted line, information of the Frame_Seq._Number field, the TC field, the CReq field, and the Credit Value field of the AFC frame can be replaced with the CCITT_CRC-16 field of the format of the data frame DF as the AFC information. As a result, the format of the data frame DF as illustrated in FIG. 11C can be defined.

The SOF field is a data frame in which the type of data frame DF corresponds to the TFS mode, and “111” indicating to include the AFC information is stored. The SOF field may have a three-bit length.

The device 10 and the device 20 each may transmit and receive the data frame corresponding to the TFS mode in the format illustrated in FIG. 11C in place of the format illustrated in FIG. 3B. A specific operation of transmission and reception may be similar to that of the first embodiment or may be similar to that of the second embodiment. Thus, the data frame DF and the AFC frame can be collectively transmitted and received in the data frame DF, whereby the data transfer efficiency can be further improved.

As described above, according to the third embodiment, in the communication method, the data frame DF is generated by adding the AFC information to the data in place of the error detection code “DL CRC” when all the data frames DF are transmitted in the TFS mode. Thus, the transfer of the AFC frame can be omitted, whereby the data transfer efficiency can be further improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication method comprising:
performing, when a first condition is satisfied for B mode that uses B transmission unit and A mode that uses A transmission unit, a first operation of generating a data frame by adding at least B error detection code corresponding to the B transmission unit to data;
performing, when a second condition is satisfied for the B mode and the A mode, a second operation of generating a data frame by adding the B error detection code to the data without adding A error detection code to the data; and
transmitting the data frame generated in the first operation or the second operation.

2. The communication method according to claim 1, wherein
performing the first operation includes performing, when a part of the data frame is transmitted in the B mode and another part of the data frame is transmitted in the A mode, the first operation of generating a data frame by adding the B error detection code and the A error detection code to the data; and
performing the second operation includes performing, when all the data frames are transmitted in the B mode, the second operation of generating a data frame by adding the B error detection code to the data without adding the A error detection code to the data.

3. The communication method according to claim 1, further comprising
switching an operation of generating a data frame from the first operation to the second operation when switching from the A mode to the B mode.

4. The communication method according to claim 3, further comprising
switching the operation of generating a data frame from the second operation to the first operation when switching from the B mode to the A mode.

5. The communication method according to claim 3, wherein
switching from the first operation to the second operation includes switching the operation of generating a data frame from the first operation to the second operation when switching from the A mode to the B mode according to a mode status signal transitioning from A mode level to B mode level.

6. The communication method according to claim 4, wherein
switching from the first operation to the second operation includes switching the operation of generating a data frame from the first operation to the second operation when switching from the A mode to the B mode according to the mode status signal transitioning from the A mode level to the B mode level; and
switching from the second operation to the first operation includes switching the operation of generating a data frame from the second operation to the first operation when switching from the B mode to the A mode according to the mode status signal transitioning from the B mode level to the A mode level.

7. The communication method according to claim 3, wherein
switching from the first operation to the second operation includes switching the operation of generating a data frame from the first operation to the second operation when switching from the A mode to the B mode according to an SOF field being changed from a first value to a second value.

8. The communication method according to claim 4, wherein
switching from the first operation to the second operation includes switching the operation of generating a data frame from the first operation to the second operation when switching from the A mode to the B mode according to the SOF field being changed from the first value to the second value; and
switching from the second operation to the first operation includes switching the operation of generating a data frame from the second operation to the first operation when switching from the B mode to the A mode according to the SOF field being changed from the second value to the first value.

9. The communication method according to claim 1, wherein
performing the second operation includes performing, when the second condition is satisfied for the B mode and the A mode, the second operation of generating a data frame by adding AFC (Acknowledgement and Flow Control) information to data in place of the A error detection code.

10. The communication method according to claim 1, wherein
the B transmission unit has a fixed length; and
the A transmission unit has a variable length.

11. The communication method according to claim 1, wherein
the B mode and the A mode conform to a predetermined communication standard.

12. The communication method according to claim 11, wherein
the predetermined communication standard includes Unipro standard.

13. The communication method according to claim 11, wherein
the B mode includes a TFS (Transport Frame Structure) mode; and
the A mode includes a non-TFS mode.

14. An interface circuit comprising:
a generator that performs, when a first condition is satisfied for B mode that uses B transmission unit and A mode that uses A transmission unit, a first operation of generating a data frame by adding at least B error detection code corresponding to the B transmission unit to data, and performs, when a second condition is satisfied for the B mode and the A mode, a second operation of generating a data frame by adding the B error detection code to the data without adding A error detection code to the data; and
a transmitter that transmits the data frame generated in the first operation or the second operation.

15. The interface circuit according to claim 14, wherein
the first condition includes a part of the data frame being transmitted in the B mode, and another part of the data frame being transmitted in the A mode; and
the second condition includes all the data frames being transmitted in the B mode.

16. The interface circuit according to claim 14, wherein
the generator switches an operation of generating a data frame from the first operation to the second operation when switching from the A mode to the B mode.

17. The interface circuit according to claim 16, wherein
the generator switches the operation of generating a data frame from the second operation to the first operation when switching from the B mode to the A mode.

18. The interface circuit according to claim 14, wherein
the generator performs, when the second condition is satisfied for the B mode and the A mode, the second operation of generating a data frame by adding AFC (Acknowledgement and Flow Control) information to data in place of the A error detection code.

19. The interface circuit according to claim 16, wherein
the transmitter is suppliable with a mode status signal to the generator; and
the generator includes switching the operation of generating a data frame from the first operation to the second operation when switching from the A mode to the B mode according to the mode status signal transitioning from A mode level to B mode level.

20. The interface circuit according to claim 17, wherein
the transmitter is suppliable with a mode status signal to the generator; and
the generator switches the operation of generating a data frame from the first operation to the second operation when switching from the A mode to the B mode according to the mode status signal transitioning from the A mode level to the B mode level, and switches the operation of generating a data frame from the second operation to the first operation when switching from the B mode to the A mode according to the mode status signal transitioning from the B mode level to the A mode level.
